(19) United States
(12) Patent Application Publication
(10) Pub. No.: US 2015/0194257 A1
(43) Pub. Date: Jul. 9, 2015

(54) INVERTER AND BOBBIN THEREOF

(71) Applicant: DELTA ELECTRONICS, INC., Taoyuan Hsien (TW)

(72) Inventors: Pi-Fan Chen, Taoyuan Hsien (TW); Zhi-Liang Zhang, Taoyuan Hsien (TW); Chih-Yung Chiu, Taoyuan Hsien (TW); Su-Chiung Hsu, Taoyuan Hsien (TW)

(73) Assignee: DELTA ELECTRONICS, INC., Taoyuan Hsien (TW)

(21) Appl. No.: 14/196,991

(22) Filed: Mar. 4, 2014

(30) Foreign Application Priority Data
Jan. 9, 2014 (TW) 103200478

(51) Int. Cl. H01F 27/32; H01F 27/28

(52) U.S. Cl. CPC H01F 27/325; H01F 27/2823

(57) ABSTRACT

An inverter includes a bobbin and a first insulated wire. The bobbin includes a main body, a first base disposed on one side of the main body and connected with the main body, a first plate disposed between the main body and the first base, among which a wire groove is formed between the first plate and the first base, and a plurality of second plates disposed on the main body for forming a plurality of first winding grooves on the main body. The first insulated wire has a winding portion disposed in the first winding grooves and a first outlet partially disposed in the wire groove, such that the first outlet is staggered with the winding portion, thereby avoiding the short circuit phenomena of the first insulated wire caused by the tear abrasion, avoiding the arc burn phenomena, and having high voltage-resistance.

### TECHNICAL FIELD

The present disclosure relates to an inverter, and more particularly to an inverter and a bobbin thereof.

### BACKGROUND

Inverters, which are indispensable elements, play an important role in lots types of electronic devices or apparatuses. With growing and developing of the applications of each type of high-voltage models in the industry, inverters are required to have high voltage-resistance and high versatility in order to meet the practical demands and the product trends.

The requirement of the voltage-resistance of a single inverter rises from 3000 volts resistance to 4000 volts resistance in mainstream products of inverters. However, an arc burn phenomena of the conventional inverter utilizing the conventional bobbin is easily occurred, such that the conventional inverter cannot be effectively utilized for bearing voltage as high as 4000 volts. Please refer to FIG. 1. FIG. 1 schematically illustrates the bottom view of a conventional inverter and a conventional bobbin according to the prior art. As shown in FIG. 1, a conventional bobbin 10 utilized by a convention inverter 1 includes a groove 101 provided for a winding body 110 of a winding 11 to wind around. The winding 11 has an initial terminal 111 and an end terminal 112, and the initial terminal 111 and the end terminal 112 are respectively connected with a pin 102 on the right side and a pin 102 on the left side. Because the contact area of the initial terminal 111 and the winding body 110 is large, the tear abrasion of the enameled coating of the winding body 110 is easily occurred. Also, the initial terminal 111 cannot be wound from the root of the groove 101 due to the height of the groove 101, so that the short circuit and ignition phenomenon may occur, and further cause the arc burn phenomena when utilizing at high voltages.

Moreover, if the initial position and the final position of the winding 11 are changed with each other, the initial terminal 111 and the end terminal 112 are changed to be respectively connected with the pin 102 on the left side and the pin 102 on the right side. Although the tear abrasion of the enameled coating may be avoided, the initial terminal 111 still cannot be wound from the root of the groove 101. Not only the risk of arc burn phenomena is not eliminated, but also the conventional inverter cannot be effectively utilized for the practical applications of the high-voltage devices or apparatuses due to the limitations of the winding position and the winding method of the winding 11, which lacks of versatility.

There is a need of providing an inverter and a bobbin thereof to obviate the drawbacks encountered from the prior art.

### BRIEF SUMMARY

The present disclosure provides an inverter and a bobbin thereof in order to eliminate the drawbacks of low voltage-resistance, less of versatility, ignition phenomena and arc burn phenomena, which cause that the conventional inverter cannot be effectively utilized for different types of the high-voltage devices or apparatuses.

The present disclosure also provides an inverter and a bobbin thereof. By utilizing a first plate between the main body and the first base for forming a wire groove and partially disposing a first outlet of the first insulated wire in the wire groove, the first outlet is staggered with the winding portion, so that the short circuit phenomena caused by the tear abrasion of the first insulated wire is avoided and the first insulated wire is wound from the root of the first winding groove, thereby avoiding the arc burn phenomena and having high voltage-resistance.

The present disclosure also provides an inverter and a bobbin thereof. Via utilizing the wire groove, the first outlet and the second outlet of the first insulated wire are respectively connected with the first pin and the second pin of the first base or respectively connected with the second pin and the first pin of the first base for meeting lots types of practical demands, so that the versatility is enhanced, the inverter is used as a standard product, which can be mass-produced, and the researching and developing costs are reduced.

In accordance with an aspect of the present disclosure, there is provided an inverter. The inverter includes a bobbin and a first insulated wire. The bobbin includes a main body, a first base, a first plate and a plurality of second plates. The first base is disposed on one side of the main body and connected with the main body. The first plate is disposed between the main body and the first base, among which a wire groove is formed between the first plate and the first base. The second plates are disposed on the main body for forming a plurality of first winding grooves on the main body. The first insulated wire has a winding portion and a first outlet. The winding portion is disposed in the first winding grooves. The first outlet is partially disposed in the wire groove, such that the first outlet is staggered with the winding portion.

In accordance with another aspect of the present disclosure, there is provided a bobbin of a first insulated wire comprising a winding portion and a first outlet. The bobbin includes a main body, a first base, a first plate and a plurality of second plates. The first base is disposed on one side of the main body and connected with the main body. The first plate is disposed between the main body and the first base, among which a wire groove is formed between the first plate and the first base. The second plates are disposed on the main body for forming a plurality of first winding grooves on the main body. The first insulated wire has a winding portion and a first outlet. The winding portion is disposed in the first winding grooves. The first outlet is partially disposed in the wire groove, such that the first outlet is staggered with the winding portion.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 schematically illustrates the bottom view of a conventional inverter and a conventional bobbin according to the prior art;

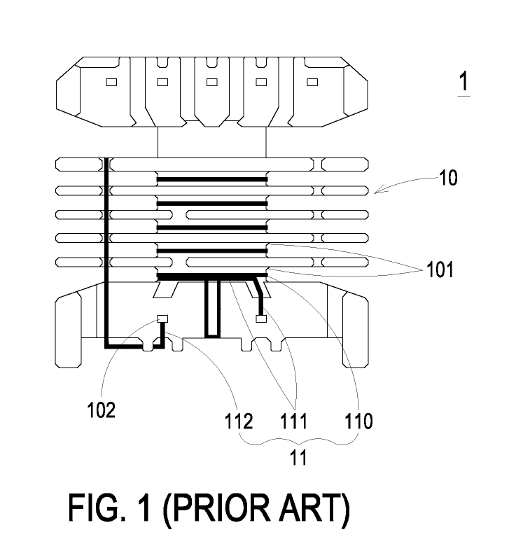

FIG. 2 schematically illustrates the bottom view of an inverter and a bobbin thereof according to an embodiment of the present invention; and

FIG. 3 schematically illustrates the bottom view of an inverter and a bobbin thereof according to another embodiment of the present invention.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

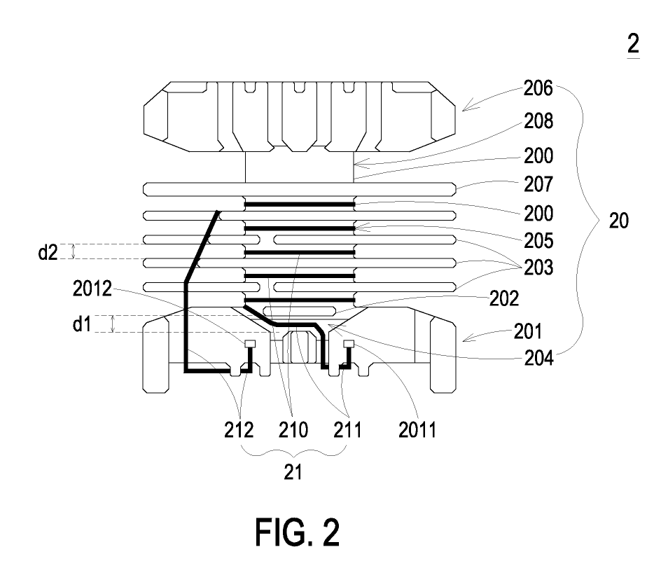

Please refer to FIG. 2. FIG. 2 schematically illustrates the bottom view of an inverter and a bobbin thereof according to an embodiment of the present invention. As shown in FIG. 2, an inverter 20 of the present invention includes a bobbin 20 and a first insulated wire 21. The bobbin 20 includes a main body 200, a first base 201, a first plate 202 and a plurality of second plates 203, and the first insulated wire 21 has a winding portion 210 and a first outlet 211. In this embodiment, the first base 201, which is not limited to a first pin base, is disposed on one side of the main body 200 and connected with the main body 200. The first plate 202 is disposed between the main body 200 and the first base 201 among which a wire groove 204 is formed between the first plate 202 and the first base 201. The second plates 203 are disposed on the main body 200 for forming a plurality of first winding grooves 205 on the main body 200. The winding portion 210 of the first insulated wire 21 is disposed in the first winding grooves 205, among which the first insulated wire 21 is an enameled wire, but not limited thereto. The first outlet 211 of the first insulated wire 21, which is not limited to a first lead or an initial terminal, is partially disposed in the wire groove 204, such that the first outlet 211 is staggered with the winding portion 210. In other words, the first outlet 211 and the winding portion 210 are discretely arranged for avoiding the ignition phenomena and the short circuit phenomena caused by the tear abrasion, winding the winding portion 210 from the root of the first winding groove 205 and avoiding the arc burn phenomena, such that the present invention achieves the advantage of high voltage-resistance.

In some embodiments, the first plate 202 and the first base 201 are arranged at a first interval d1, and the length of the first interval d1 is equal to the width of the wire groove 204, but not limited thereto. In addition, the second plates 203 are discretely arranged at second intervals d2, and each of the second plates 203 is parallel to each other. In another embodiments, the length of the first interval d1 is equal to the length of the second interval d2, or the length of the first interval d1 is unequal to the length of the second interval d2, but not limited thereto.

In accordance with an aspect of the present invention, the bobbin 20 further includes a second base 206 and a third plate 207. The second base 206, which is not limited to be a second pin base, is disposed on the other side of the main body 200 and connected with the main body 200. The third plate 207 is disposed between the second plate 203 and the second base 206 for forming a second winding groove 208 between the third plate 207 and the second base 206.

In some preferred embodiments, the inverter 2 further includes a second insulated wire at least partially wound on the second winding groove 208 (not shown), among which the second insulated wire is a primary winding, and the first insulated wire 21 is a secondary winding, but not limited thereto.

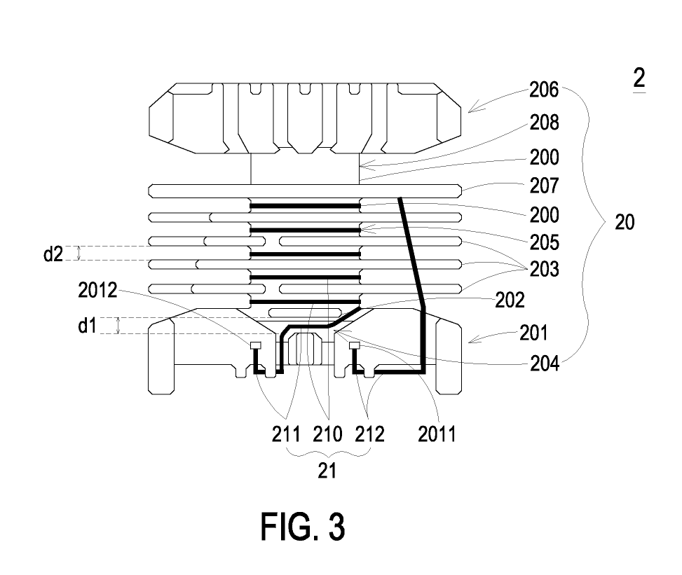

Please refer to FIG. 2 and FIG. 3. FIG. 3 schematically illustrates the bottom view of an inverter and a bobbin thereof according to another embodiment of the present invention. As shown in FIG. 2 and FIG. 3, in some embodiments, the first base 201 has a first pin 2011 and a second pin 2012, and the first insulated wire 21 has a second outlet 212, among which the second outlet 212 is not limited to a second lead or an end terminal. Via utilizing the wire groove 204, the first outlet 211 and the second outlet 212 of the first insulated wire 21 are respectively connected with the first pin 2011 and the second pin 2012 of the first base 201 (as shown in FIG. 2) or respectively connected with the second pin 2012 and the first pin 2011 of the first base 201 (as shown in FIG. 3) for meeting lots types of practical demands, so that the versatility is enhanced, the inverter is used as a standard product, which can be mass-produced, and the researching and developing costs are reduced.

From the above description, the present disclosure provides an inverter and a bobbin thereof. By utilizing a first plate between the main body and the first base for forming a wire groove and partially disposing a first outlet of the first insulated wire in the wire groove, the first outlet is staggered with the winding portion, so that the short circuit phenomena caused by the tear abrasion of the first insulated wire is avoided and the first insulated wire is wound from the root of the first winding groove, thereby avoiding the arc burn phenomena and having high voltage-resistance. Meanwhile, via utilizing the wire groove, the first outlet and the second outlet of the first insulated wire are respectively connected with the first pin and the second pin of the first base or respectively connected with the second pin and the first pin of the first base for meeting lots types of practical demands, so that the versatility is enhanced, the inverter is used as a standard product, which can be mass-produced, and the researching and developing costs are reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An inverter, comprising:
a bobbin comprising:
a main body;
a first base disposed on one side of the main body and connected with the main body;
a first plate disposed between the main body and the first base, wherein a wire groove is formed between the first plate and the first base; and
a plurality of second plates disposed on the main body for forming a plurality of first winding grooves on the main body; and
a first insulated wire having a winding portion and a first outlet, wherein the winding portion is disposed in the first winding grooves, and the first outlet is partially disposed in the wire groove, such that the first outlet is staggered with the winding portion.

2. The inverter according to claim 1, wherein the first base has a first pin and a second pin, and the first insulated wire has a second outlet.

3. The inverter according to claim 2, wherein the first outlet is connected with the first pin, and the second outlet is connected with the second pin.

4. The inverter according to claim 2, wherein the first outlet is connected with the second pin, and the second outlet is connected with the first pin.

5. The inverter according to claim 1, wherein the first plate and the first base are arranged at a first interval, and the length of the first interval is equal to the width of the wire groove.

6. The inverter according to claim 5, wherein the second plates are discretely arranged at second intervals, and each of the second plates is parallel to each other.

7. The inverter according to claim 6, wherein the length of the first interval is equal to the length of the second interval, or the length of the first interval is unequal to the length of the second interval.

8. The inverter according to claim 1, wherein the bobbin further comprises:
a second base disposed on the other side of the main body and connected with the main body; and
a third plate disposed between the second plate and the second base for forming a second winding groove between the third plate and the second base.

9. The inverter according to claim 8, further comprising a second insulated wire at least partially wound on the second winding groove, wherein the second insulated wire is a primary winding, and the first insulated wire is a secondary winding.

10. A bobbin of a first insulated wire comprising a winding portion and a first outlet, comprising:
a main body;
a first base disposed on one side of the main body and connected with the main body;
a first plate disposed between the main body and the first base, wherein a wire groove is formed between the first plate and the first base; and
a plurality of second plates disposed on the main body for forming a plurality of first winding grooves on the main body, wherein the winding portion is disposed in the first winding grooves, and the first outlet is partially disposed in the wire groove, such that the first outlet is staggered with the winding portion.
